(19) United States
(12) Patent Application Publication
(10) Pub. No.: US 2008/0131649 A1
(43) Pub. Date: Jun. 5, 2008

(54) LOW MELT PRIMARY CARPET BACKINGS AND METHODS OF MAKING THEREOF

(76) Inventors: David M. JONES, Dacula, GA (US); Wilson B. HARVIE, Statham, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/565,044

(22) Filed: Nov. 30, 2006

(51) Int. Cl. D05C 17/02; B32B 33/00; D05C 15/04

(52) U.S. Cl. 428/95; 156/72

(57) ABSTRACT

Described herein are primary carpet backings that possess improved physical properties such as tuft binding strength. The backings described herein can be easily recycled and re-used. Also described herein are methods for making and recycling primary carpet backings.

### BACKGROUND

In the conventional manufacture of carpet, yarns are tufted or pushed through a primary backing material. Primary backings are typically woven or non-woven fabrics made of one or more natural or synthetic fibers or yarns, such as jute, wool, polypropylene, polyethylene, polyamides, polyesters, and rayon. Films of synthetic materials, such as polypropylene, polyethylene and ethylene-propylene copolymers, also can be used to form the primary backing.

The tufts of yarn inserted into the primary backing during the tufting process are usually held in place by untwisting of the yarn as well as shrinkage of the primary backing. In the finishing operation, the backside or stitched surface of the primary backing usually is coated with an adhesive, a.k.a. a back coat, such as a natural or synthetic rubber, resin latex, emulsion or a hot melt adhesive, to enhance locking or anchoring of the tufts to the backing. Basic requirements for adhesives include the ability to bond strongly to the primary backing, the tuft stitches protruding through its backside, and the secondary backing. Another backing material is brought into contact with the adhesive under pressure, with melting and subsequent cooling of the adhesive serving to bond the backing materials. An alternative to carpet lamination processes using hot melt adhesives involves forming hot melt polymers or other thermoplastics into a continuous sheet or film and directing it between primary and secondary backings, heating the backings in contact with the molten thermoplastic adhesive, and then solidifying the hot melt adhesive to form a high strength laminate or composite.

Generally, a tufted carpet is further stabilized in the finishing operation by laminating a secondary backing, for example, a thermoplastic film or a woven or non-woven fabric made from polypropylene, polyethylene, or ethylene-propylene copolymers or natural fibers such as jute, to the tufted primary backing. The adhesive used in the finishing operation bonds the primary backing to the secondary backing.

The above-described methods for making carpet are used in most carpet made in the United States. However, these methods have both process and environmental disadvantages. The environmental disadvantages associated with use of the traditional latex are generally two-fold. First, the latex hinders the recycling of the used carpet and scrap product (e.g., salvage and off-spec carpet) because the latex is a thermoset and cannot generally be re-melted or re-used. Additionally, the latex causes sticking in molds and other recycling devices and releases odors upon heating. Finally, the latex requires excessive energy to be applied to recycle product containing the latex. With the decreasing availability and increasing cost of suitable landfills for such scrap, the carpet industry has experienced a need for finding other alternatives.

Indeed, the issue of recycling with respect to scrap alone is a serious problem, notwithstanding the fact that the face yarns and backings typically used in a carpet are made from all-thermoplastic materials. Once these components are contaminated with the filled latex (which includes a very significant component of inorganic filler, e.g., calcium carbonate), they are difficult to recycle economically, because of the aforementioned technical problems.

Traditional approaches to recycling and reuse have involved separating the individual components to be reused or making do with mixtures of components, which often render the recycled materials suitable for only uses in products of a lower quality. Separating individual components of multilayered products, while often more feasible than separating more homogeneous mixtures, can nevertheless present significant difficulties where the layers are held together with adhesive. Often, the separation processes render one or more of the components unusable or usable only after significant additional processing. For example, processes that involve heating polyurethanes to very high temperatures can often result in irreversible degradation of the polyurethane molecule and rendering it unsuitable for recycle or reuse.

An approach for improving recycling has been disclosed by Hoechst Celanese Corporation of Salisbury, N.C., in a paper entitled “All-Polyester Carpet System: Environmental and Performance Aspects,” presented by L. G. Stockman, et al. at the International Durable Needlepunch Conference on Apr. 20, 1994 (previously summarized in “The Carpet Recycling Newsletter”) Volume 93, No. 7 (September 1993). See also, European Pat. Appl. 0 568 916 A1, published Nov. 10, 1993. According to this report, carpet may be constructed using a tufted polyester felt primary backing together with a polyester secondary backing, each backing containing a certain percentage of hetero-filled fiber with a low-melt sheath (binder fibers) intimately mixed with non-binder fibers. The backings are then needled together and heat-treated. This results in the production of an all-polyester carpet; however, this carpet possesses modest physical properties. In addition, this approach uses a non-woven primary backing and a non-woven secondary backing, both of which are heavier than woven polypropylene backing typically used in the industry.

Thus, what is needed is a carpet backing that does not require the use of adhesives to bind tufts to the backing. Additionally, the carpet backing should be easily recyclable to address environmental concerns. The carpet backings described herein address these and other needs present in the carpet industry.

### SUMMARY

Described herein are primary carpet backings that possess improved physical properties such as tuft binding strength. The backings described herein can be easily recycled and re-used. Also described herein are methods for making and recycling primary carpet backings. The advantages of the invention will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive

### DETAILED DESCRIPTION

Before the present compounds, compositions, articles, devices, and/or methods are disclosed and described, it is to be understood that the aspects described below are not limited to specific synthetic methods, as such may, of course, vary. It is also to be understood that the terminology used herein is for the purpose of describing particular aspects only and is not intended to be limiting.

In this specification and in the claims that follow, reference will be made to a number of terms that shall be defined to have the following meanings:

It must be noted that, as used in the specification and the appended claims, the singular forms “a,” “an,” and “the” include plural referents unless the context clearly dictates otherwise. Thus, for example, reference to “an adhesion agent” includes mixtures of adhesion agents; reference to “a fiber” includes mixtures of two or more fibers, and the like.

“Optional” or “optionally” means that the subsequently described event or circumstance may or may not occur, and that the description includes instances where the event or circumstance occurs and instances where it does not.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

### A. Primary Carpet Backings

Described herein are primary carpet backings with improved physical properties. In one aspect, the primary backing comprises (1) a first fabric comprising polypropylene, and (2) a second fabric comprising a metallocene polypropylene, wherein the first fabric and the second fabric are physically attached to one another.

The first fabric of the primary backing is composed of polypropylene. In certain aspects, the first fabric is only polypropylene with no other polymers (e.g., polyethylene). Although the first fabric can be woven or non-woven, it is preferred that first fabric be woven to ensure good attachment to the second fabric. Woven fabrics of polypropylene and techniques for making the same are known in the art. The melting point of the polypropylene used in the first fabric is higher than the melting point of the metallocene polypropylene used in the second fabric. In one aspect, the melting point of the polypropylene in the first fabric is greater than 165° C.

The second fabric is composed of a metallocene polypropylene. The term “metallocene polypropylene” is defined herein as any polypropylene that was produced in the presence of metallocene catalyst. By selecting a particular catalyst and reaction conditions, it is possible to produce polypropylene with specific properties such as, for example, molecular weight, melting point, and tacticity. The procedures disclosed in U.S. Pat. No. 7,132,382 for using metallocene catalysts to prepare polypropylene can be used to produce metallocene polypropylenes useful herein. The metallocene polypropylene can be atactic, isotactic, hemi-isotactic, or syndiotactic.

In one aspect, the metallocene polypropylene has a melting point less than 145° C., or from 120° C. to 145° C. In a further aspect, when the first fabric is composed of polypropylene, the melting point of the polypropylene of the first fabric is greater 165° C. and the melting point of the metallocene polypropylene of the second fabric is less than 145° C.

In one aspect, the metallocene polypropylene has a melt flow index greater than 10 g/10 min @ 230° C. as measured by ASTM D1238. In another aspect, the metallocene polypropylene has a melt flow index of from 10 to 100 g/10 min @ 230° C., from 30 to 90 g/10 min @ 230° C., from 40 to 80 g/10 min @ 230° C., or about 50 g/10 min @ 230° C. It is desirable that the metallocene polypropylene completely melt upon thermal processing to ensure that the metallocene polypropylene comes into intimate contact with the first fabric and the tufted carpet yarn. Examples of metallocene polypropylenes useful herein include Polypropylene 1751 (a syndiotactic polypropylene with a MFI of 20 g/10 min as measured by ASTM D-1238 and melting point of 130° C.) and Polypropylene M3865 (an isotactic polypropylene with a MFI of 31 g/10 min as measured by ASTM D-1238 and melting point of 130° C.) both manufactured by Total Petrochemicals USA, Inc.

The second fabric composed of metallocene polypropylene can be prepared as a woven or non-woven fabric; however, non-woven fabrics are preferred. Techniques generally known for preparing woven and non-woven fabrics can be used to prepare the second fabric.

In certain aspects, additional components can be incorporated into the second fabric. In one aspect, a compatibilizer can be incorporated into the second fabric. The addition of a compatibilizer can be particularly useful when the tuft of the carpet is not a polypropylene. The compatibilizer can be admixed with the metallocene polypropylene prior to formation of the second fabric or, in the alternative, can be applied to the second fabric by spraying, coating, or dipping the compatibilizer on the second fabric. In one aspect, the compatibilizer is intimately admixed with the metallocene polypropylene and extruded to produce fibers.

In one aspect, the compatibilizer comprises a polyolefin such as, for example, polypropylene, grafted with an unsaturated carboxylic acid, anhydride, ester, or any combination thereof. Examples of such acids and anhydrides include, but are not limited to, maleic acid, maleic anhydride and derivatives thereof such as citraconic acid, citraconic anhydride and pyrocinchonic anhydride; fumaric acid and derivatives thereof; unsaturated derivatives of malonic acid such as 3-butene-1,1-dicarboxylic acid, benzylidene malonic acid and isopropylidene malonic acid; and unsaturated derivatives of succinic acid such as itaconic acid and itaconic anhydride.

In one aspect, maleic acid and maleic anhydride are grafted onto polyolefin. When these compounds are grafted onto the polyolefin, the resulting chain is provided with succinic acid or succinic anhydride groups, respectively. The grafting of the dicarboxylic acid, anhydride, or ester thereof onto the polyolefin may be performed using techniques known in the art. See U.S. Pat. Nos. 4,950,541 and 4,684,576, which are incorporated by reference for their teachings of grafting unsaturated carboxylic acids, anhydrides, and esters to polyolefins.

The amount of compatibilizer that is used in the second fabric can vary. In one aspect, the weight ratio of compatibilizer to metallocene polypropylene in the second fabric is from about 1:99 to 50:50, from about 1.5:98.5 to 30:70, from about 2:98 to 20:80, from about 3:97 to 15:85, or from about 5:95 to 10:90. In one aspect, the amount of compatibilizer is about 7.5% by weight of a maleated polymer. The content of carboxylic acid, anhydride, or ester groups can be in the range of about 1 to 30% by weight, from about 2 to 20% by weight, from about 3 to 15% by weight, or from about 5 to 10% by weight of the compatibilizer.

In one aspect, the compatibilizer comprises a maleated random-polypropylene copolymer sold as Fusabond MZ-278D by E.I. DuPont de Nemours & Company. Other examples of compatibilizers useful herein include maleated polyethylene wax sold by Eastman Chemicals, Inc. as “C-18,” or ethylene-acrylic acid copolymers containing 3 to 20 percent acrylic acid, available from Exxon Chemicals, and maleated polymers sold by Chemtura.

The primary backings described herein can further comprise other components typically used in the carpet industry including flame retardants, dyes, antimicrobials, antistatic compounds, antifungals, or any combination thereof. These additional components can be applied directly to the backing using techniques known in the art. In another aspect, these components can be added to the metallocene polypropylene prior to the manufacture of the second fabric. In this aspect, the additional components (e.g., the compatibilizer) are evenly dispersed throughout the second fabric.

### B. Methods

Described herein are methods for making primary carpet backings. In one aspect, the method comprises attaching (i) a first fabric comprising polypropylene, and (ii) a second fabric comprising a metallocene polypropylene to produce a primary backing.

In another aspect, a method for making carpet comprises (a) tufting any of the primary backing described herein with yarn to produce a tufted article; (b) heating the tufted article at a temperature great enough to melt the metallocene polypropylene of the second fabric but less than the melting point of the polypropylene of the first fabric; and (c) cooling the tufted article so that the metallocene polypropylene binds to the tuft.

The primary backings described herein can be produced by physically attaching a first fabric comprising polypropylene and a second fabric comprising a metallocene polypropylene. Methods for attaching the fabrics are known in the art. For example, the first and second fabrics can be placed side-by-side and exposed to heat such that the metallocene polypropylene melts and binds the second fabric to the first fabric. In another aspect, the second fabric is needle-punched to the first fabric. In this aspect, the needle of the needle puncher pushes the metallocene polypropylene into the first fabric. In one aspect, up to 10%, up to 15%, or up to 20% by weight of the metallocene polypropylene is pushed through the first fabric upon needle punching the second fabric to the first fabric. It is contemplated that two or more different second fabrics can be attached to the first fabric. Upon subsequent heating, the metallocene polypropylene that is inserted in and through the first fabric anchors the second fabric to the first fabric, which ultimately produces a stronger and more stable primary backing.

Once the primary backing is produced, the backing is tufted with carpet yarn. The yarn can be made of any fiber typically used to manufacture carpet, including polyolefins (e.g., polypropylene, polyethylene), polyesters, and polyamides. Techniques for tufting primary backings are known in the art and can be used herein. In one aspect, the yarn is tufted through the first fabric followed by the second fabric.

After tufting the primary backing, the tufted article is heated to a temperature that melts the metallocene polypropylene of the second fabric but not the polypropylene of the first fabric. Upon reaching the melting point of the metallocene polypropylene, the polymer begins to melt and flow. Here, the melted metallocene polypropylene comes into intimate contact with the yarn and the first fabric. The temperature, pressure, and duration of heating will vary depending upon the selection of the metallocene polypropylene. Techniques for heating the tufted article are known in the art. For example, hot drum laminators and conventional drying ovens can be used. In one aspect, the tufted article is heated in a tenter oven via an “s” wrap roll system or a two roll nip with variable pressure control. In certain aspects, when a compatibilizer is not used, higher temperatures and pressures may be required.

When the heat is removed, the metallocene polypropylene solidifies and acts like an adhesive, which bonds the tuft to the first fabric. Thus, the tufts are locked in the first fabric without using conventional latex binders. This results in a 100% recyclable thermoplastic, latex free product. No subsequent processing steps are needed to produce a carpet having suitable properties for end use. For example, it is not necessary to use a secondary backing, which adds to increased production costs and overall weight of the carpet. Additionally, carpet produced with the primary backings described herein has improved properties such increased tuft bind.

Another advantage of using the primary backings described herein is that the carpet can be recycled for future use. In one aspect, a method for recycling carpet comprises (a) heating the carpet comprising the primary backing described herein at a temperature to melt the carpet to produce a molten solid and (b) cooling the molten solid. The entire carpet is heated to the melting temperature of the face yarn where the backing will be converted to the molten state to produce a melt stream. When the carpet contains yarn made of a fiber other than polypropylene (e.g., Nylon), a compatibilizer present in the primary backing bonds to the Nylon in the melt stream. This melt stream is solidified and chopped into recycled pellets, which can be used as a raw material for other thermoplastic end uses.

### EXAMPLES

The following examples are put forth so as to provide those of ordinary skill in the art with a complete disclosure and description of how the compounds, compositions, articles, devices, and/or methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

### Example 1

Metallocene polypropylene purchased from Fibervisions, L.P. is air fed to the card. A web is formed from the card and this web is cross-lapped over multiple layers. The web is fed into a needle loom that mechanically entangles the fibers together providing the strength needed. A woven polypropylene fabric is then introduced and married to the needled web of metallocene polypropylene and the two are then needled together in line. The secondary needling process has fewer needles and also mechanically attaches the two fabrics. The composite is then rolled onto a core for shipment and subsequent tufting. The tufting process involves pushing a needle threaded with carpet yarn through the backing produced above and creating loops or cut pile yarns to remain in the face of the fabric. The yarn is composed of Nylon.

Samples with and without maleated polypropylene (compatibilizer) were tested for tuft bind strength. All of the samples were 11 pick density woven polyolefin backing with 12-13 osy metallocene polypropylene needled in the polypropylene fabric. The samples were subjected to heat and pressure with various dwell times. The heat is IR heat with the samples exposed to heat at 25′/min in a heated calendar at 25 psi. The heated cylinders were at 130° C. and 150° C. top to bottom. High heat is defined as the temperature needed to just melt the adhesive layer run at slower speeds or pressures (i.e., maximum dwell time). These samples have a glossy back with no unmelted fibers. The medium heat samples have some fusing occurring but not all the way through the adhesive layer and the samples are not clear but white. The low heat samples are still displaying loose-needled unfused fibers in some places and the samples are still white.

The tuft bind results as determined by ASTM D 1335-05 are Summarized in Table 1. The data indicates that the use of the compatibilizer increases the tuft bind strength (lbs) of the carpet.

TABLE 1

| | High heat | Medium Heat | Low heat |
|---|---|---|---|
| No compatibilizer | 10.54 lbs | 4.46 lbs | 2.48 lbs |
| Compatibilizer | 13.25 lbs | 9.49 lbs | 4.11 lbs |

Throughout this application, various publications are referenced. The disclosures of these publications in their entireties are hereby incorporated by reference into this application in order to more fully describe the compounds, compositions and methods described herein.

Various modifications and variations can be made to the compounds, compositions and methods described herein. Other aspects of the compounds, compositions and methods described herein will be apparent from consideration of the specification and practice of the compounds, compositions and methods disclosed herein. It is intended that the specification and examples be considered as exemplary.

What is claimed is:

1. A primary backing for carpet, wherein the primary backing comprises (1) a first fabric comprising polypropylene, and (2) a second fabric comprising a metallocene polypropylene, wherein the first fabric and the second fabric are physically attached to one another.

2. The backing of claim 1, wherein the first fabric and the second fabric are needled-punched to each other.

3. The backing of claim 1, wherein the first fabric comprises a woven fabric.

4. The backing of claim 1, wherein the second fabric comprises a non-woven fabric.

5. The backing of claim 1, wherein the difference in melting points between the polypropylene of the first fabric and the metallocene polypropylene of the second fabric is greater than 25° C.

6. The backing of claim 1, wherein the melting point of the polypropylene of the first fabric is greater 165° C. and the melting point of the metallocene polypropylene of the second fabric is less than 145° C.

7. The backing of claim 1, wherein the metallocene polypropylene has a melting point less than 145° C.

8. The backing of claim 1, wherein the metallocene polypropylene has a melt flow index greater than 10 g/10 min at 230° C. as measured by ASTM D1238.

9. The backing of claim 1, wherein the second fabric further comprises a compatibilizer.

10. The backing of claim 9, wherein the compatibilizer comprises a polymer grafted with an unsaturated carboxylic acid, anhydride, ester, or any combination thereof.

11. The backing of claim 10, wherein the polymer comprises a polyolefin.

12. The backing of claim 10, wherein the polymer comprises polypropylene.

13. The backing of claim 10, wherein the amount of carboxylic acid groups, anhydride groups, or ester groups grafted to the polymer is from 1 to 30% by weight of the compatibilizer.

14. The backing of claim 10, wherein the amount of carboxylic acid groups, anhydride groups, or ester groups grafted to the polymer is from 5 to 10% by weight of the compatibilizer.

15. The backing of claim 9, wherein the compatibilizer comprises a polymer grafted with citraconic acid, citraconic anhydride, pyrocinchonic anhydride, fumaric acid or a derivative thereof; 3-butene-1,1-dicarboxylic acid, benzylidene malonic acid, isopropylidene malonic acid, itaconic acid, itaconic anhydride, or any combination thereof.

16. The backing of claim 9, wherein the compatibilizer comprises a polymer grafted with maleic acid, maleic anhydride, or a mixture thereof.

17. The backing of claim 9, wherein the polymer comprises polypropylene.

18. The backing of claim 9, wherein the compatibilizer comprises a maleated random-polypropylene copolymer.

19. The backing of claim 1, wherein the backing further comprises a flame retardant, a dye, an antimicrobial, an antistatic compound, an antifungal, or any combination thereof.

20. A carpet comprising the primary backing of claim 1.

21. The carpet of claim 20, wherein the carpet does not contain an adhesive.

22. The carpet of claim 20, wherein the carpet does not contain a secondary backing.

23. A method of producing a primary carpet backing comprising attaching (i) a first fabric comprising polypropylene, and (ii) a second fabric comprising a metallocene polypropylene to produce the primary backing.

24. A method of producing a carpet comprising (a) tufting the backing of claim 1 with yarn to produce a tufted article; (b) heating the tufted article at a temperature great enough to melt the metallocene polypropylene of the second fabric but less than the melting point of the polypropylene of the first fabric; and (c) cooling the tufted article so that the metallocene polypropylene binds to the tuft.

25. A method of recycling carpet comprising (a) heating the carpet comprising the primary backing described herein at a temperature to melt the carpet to produce a molten solid and (b) cooling the molten solid.
